(19) United States
(12) Patent Application Publication
(10) Pub. No.: US 2004/0203408 A1
(43) Pub. Date: Oct. 14, 2004

(54) System and method for logging in an interactive instructional system

(76) Inventors: Say-Yee Wen, Taipei (TW); Shih-Li Wen, Taipei (TW)

Correspondence Address: BIRCH STEWART KOLASCH & BIRCH, PO BOX 747, FALLS CHURCH, VA, 22040-0747, US

(21) Appl. No.: 10/192,588

(22) Filed: Jul. 11, 2002

(51) Int. Cl. H04B 7/00

(52) U.S. Cl. 455/66.1; 455/260; 455/435.1; 455/556.1

(57) ABSTRACT

A system and method for logging in an interactive instructional system is provided. The interactive instructional system applies portable electronic data processing and communication devices, such as personal digital assistants (PDA), notebook computers or mobile phones. A teacher portable data processing device and several student portable data processing devices join a wireless local-area network (LAN). The portable data processing devices perform a fast checking of student attendance and display a real-time attendance status of students on the teacher portable data processing device. Therefore, the teacher can monitor the attendance condition of students in real time without wasting any time and effort.

### BACKGROUND OF THE INVENTION

1. Field of the Invention

The invention generally relates to a system and method for communication among electronic data processing devices, and particularly relates to a system and method for logging in an interactive instructional system with a plurality of portable data processing and communication devices.

2. Related Art

In the era of explosive information, people require abilities of collecting, processing and transferring digitized information. In order to comply with the trend of information processing and to reduce burdens of students, the manners of education have to be revolutionized. For convenience of information carrying and good for operation, small and light-weighted digital information devices and wireless personal communication methods are now being well developed. The invention provides an interactive instructional method in which portable data processing and communication devices, such as personal digital assistants (PDA), are applied.

The interactive instructional methods through portable data communication and processing devices prevent students from waiting physical computer facilities at schools. The students can retrieve instructional resources of schools anytime and anywhere. The teachers can also monitor the learning progresses of students and interact with students through network communication.

In conventional instructional methods, a teacher has to spend 5 or 10 minutes in each class to check attendance of the students. That means one fifth or one tenth of the class time, i.e., 40 to 80 minutes for 8 classes a day, are wasted. However, if the teacher does not waste time to check attendance of students, he or she cannot get the attendance condition of the students, and the students may become lazy and absent frequently. Some schools hire people to check attendance outside the classrooms by checking the seats. This still costs, and the teachers still cannot get the attendance condition in time.

Therefore, the invention provides a log-in method for an interactive instructional system that incorporates personal digital assistants of teacher and students. The PDA log-in process will provide the teacher with the attendance condition of students in real time.

### SUMMARY OF THE INVENTION

The object of the invention is to provide a system and method for logging in an interactive instructional system. The interactive instructional system applies portable electronic data processing and communication devices, such as personal digital assistants (PDA), notebook computers or mobile phones. An instructor portable data processing device and several learner portable data processing devices join a wireless local-area network (LAN). The portable data processing devices perform a fast checking of student attendance and display a real-time attendance status of students on the instructor portable data processing device.

A system and method for logging in an interactive instructional system according to the invention applies portable electronic data processing and communication devices. An instructor portable data processing/communication device and several learner portable data processing/communication devices join a wireless local-area network. The local area covers a classroom or other limited area. The portable data processing/communication devices can be several personal digital assistants, which includes an instructor PDA for the teacher and some other learner PDAs for the students.

The instructor portable data processing and communication device includes an input unit, a wireless transceiver, a memory unit, a display unit and a central processing unit. The input unit is used for input of instructional commands and related information. The wireless transceiver is used to transmit instructional information to pluralities of learner portable data processing and communication devices, and to receive registration information from these devices. The memory unit stores the registration information of the learner portable data processing and communication devices. The display unit displays the registration result. The central processing unit is connected with the input unit, the wireless transceiver, the memory unit and the display unit for executing the registration commands for transmitting information through the wireless transceiver, and transferring the information received by the transceiver to the display unit and the memory unit.

The learner portable data processing and communication device includes a wireless transceiver, an input unit, a memory unit, a display unit and a central processing unit. The wireless transceiver is used to receive instructional information from the instructor portable data processing and communication device, and to transmit registration information to the instructor device. The input unit is used for input of registration information. The display unit displays the instructional information. The memory unit stores the instructional information of the instructor portable data processing and communication device. The central processing unit is connected with the input unit, the wireless transceiver, the memory unit and the display unit for executing the instructional commands for transmitting information through the wireless transceiver, and transferring the information received by the transceiver to the display unit and the memory unit.

By the aforesaid system, a method for logging in an interactive instructional system according to the invention includes the steps of: starting a local-area network among learner and instructor portable data processing and communication devices; inputting a class-starting command for setting the learner and instructor portable data processing and communication devices into a class-staring mode; transmitting registration information from the learner portable data processing and communication devices to the instructor portable data processing and communication device; receiving transmitting registration information by the instructor portable data processing and communication device; identifying corresponding positions of the learner portable data processing and communication devices according to the registration information; and displaying and recording the registration result of learner portable devices at the instructor device.

In the aforesaid system and method, a timing process can also be included. The process includes steps of: counting a time period T after a class starts; adding a “LATE” tag to a learner's registration information displayed on the instructor device when the learner logs in after the time period T; and transmitting a “LATE” notice to the late log-in learner's device when the learner attends after the time period T.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is a block diagram of an interactive instructional system of the invention that includes a plurality of personal digital assistants;

FIG. 2 is a descriptive view of an interactive instructional system of the invention that includes a plurality of personal digital assistants joining a local-area network;

FIG. 3 is a main flowchart of a method for logging in an interactive instructional system according to the invention;

FIG. 4 is an example of a display showing learner's attendance condition at an instructor PDA of the invention;

FIG. 5 is an example of a display showing a “LATE” notice at a learner PDA of the invention;

FIG. 6 is an operational flowchart of an instructor PDA of the invention; and

FIG. 7 is an operational flowchart of a learner PDA of the invention.

### DETAILED DESCRIPTION OF THE INVENTION

The invention provides a system and method for logging in an interactive instructional system. The interactive instructional system applies portable electronic data processing and communication devices, such as personal digital assistants (PDA), notebook computers or mobile phones. An instructor (teacher) portable data processing device and several learner (student) portable data processing devices join a wireless local-area network (LAN). The portable data processing devices perform a fast checking of student attendance and display a real-time attendance status of students on the teacher portable data processing and communication device.

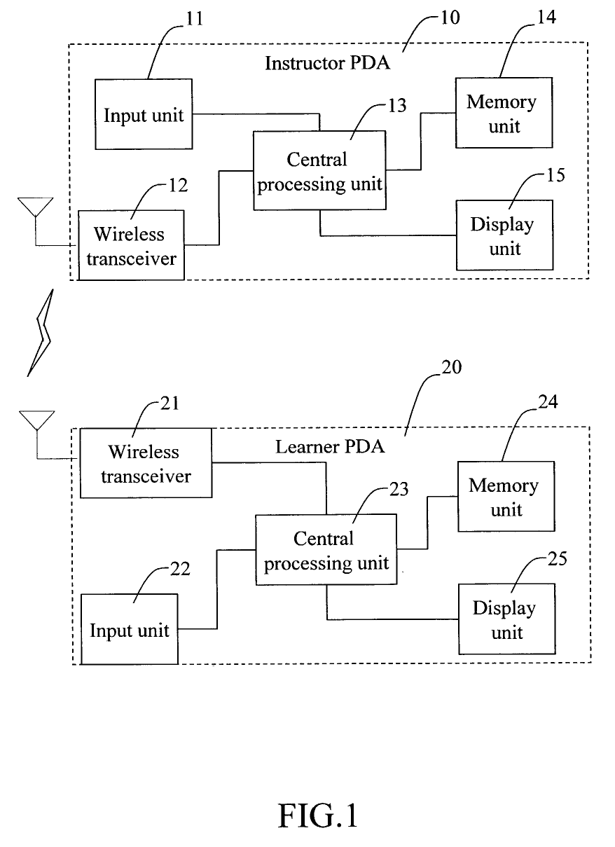

As shown in FIG. 1, a system for logging in an interactive instructional system according to the invention applies several portable electronic data processing and communication devices. An instructor (teacher) portable data processing/communication device (such as PDA) 10 and several learner (student) portable data processing/communication devices (PDA) 20 join a wireless local-area network. The instructor portable data processing and communication device 10 includes an input unit 11, a wireless transceiver 12, a memory unit 14, a display unit 15 and a central processing unit 13. The input unit 11 is used for input of instructional commands and related information. The wireless transceiver 12 is used to transmit instructional information to pluralities of learner portable data processing and communication devices 20, and to receive registration information from these devices 20. The memory unit 14 stores the registration information of the learner portable data processing and communication devices 20. The display unit 15 displays the registration result. The central processing unit 13 is connected with the input unit 11, the wireless transceiver 12, the memory unit 14 and the display unit 15 for executing the registration commands for transmitting information through the wireless transceiver 12, and transferring the information received by the transceiver 12 to the display unit 15 and the memory unit 14.

Each of the learner portable data processing and communication devices 20 includes a wireless transceiver 21, an input unit 22, a memory unit 24, a display unit 25 and a central processing unit 23. The wireless transceiver 21 is used to receive instructional information from the instructor portable data processing and communication device 10, and to transmit registration information to the instructor device 20. The input unit 22 is used for input of registration information. The display unit 25 displays the instructional information. The memory unit 24 stores the instructional information of the instructor portable data processing and communication device 10. The central processing unit 23 is connected with the input unit 22, the wireless transceiver 21, the memory unit 24 and the display unit 25 for executing the instructional commands for transmitting information through the wireless transceiver 21, and transferring the information received by the transceiver 21 to the display unit 25 and the memory unit 24.

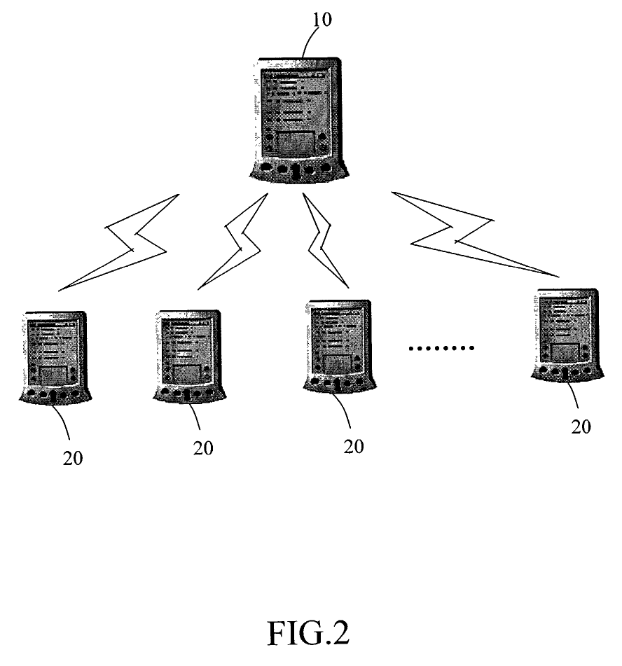

As shown in FIG. 2, an interactive instructional system of the invention includes a plurality of personal digital assistants joining a local-area network. It includes an instructor portable data processing/communication device 10 and several learner portable data processing/communication devices 20. The devices 10 and 20 joint a wireless local-area network so that the attendance checking of learners for the instructor can be finished automatically through communication of the devices.

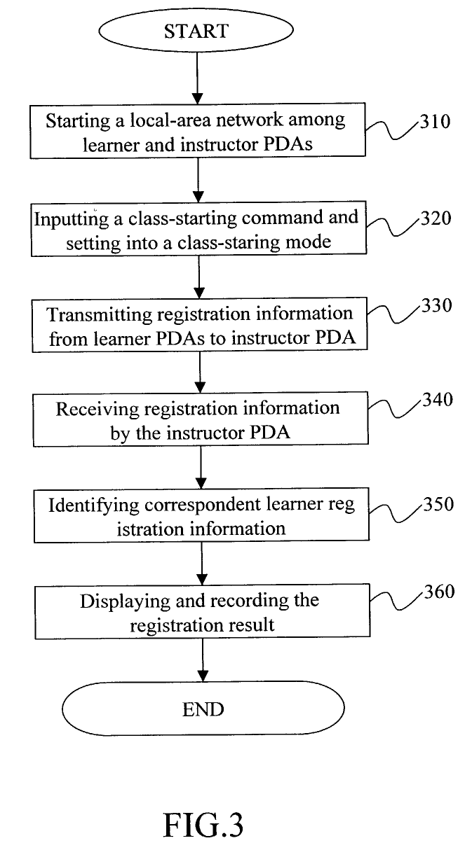

As shown in FIG. 3, a method for logging in an interactive instructional system according to the invention includes the following steps. First, starting a local-area network among learner and instructor portable data processing and communication devices (step 310). Then, inputting a class-starting command to the instructor device for setting the learner and instructor portable data processing and communication devices into a class-staring mode (step 320). Further, transmitting registration information from the learner portable data processing and communication devices to the instructor portable data processing and communication device (step 330). Then, receiving registration information by the instructor portable data processing and communication device (step 340). And then, identifying corresponding positions of the learner portable data processing and communication devices according to the registration information (step 350). Finally, displaying and recording the registration result of learner portable devices at the instructor device (step 360).

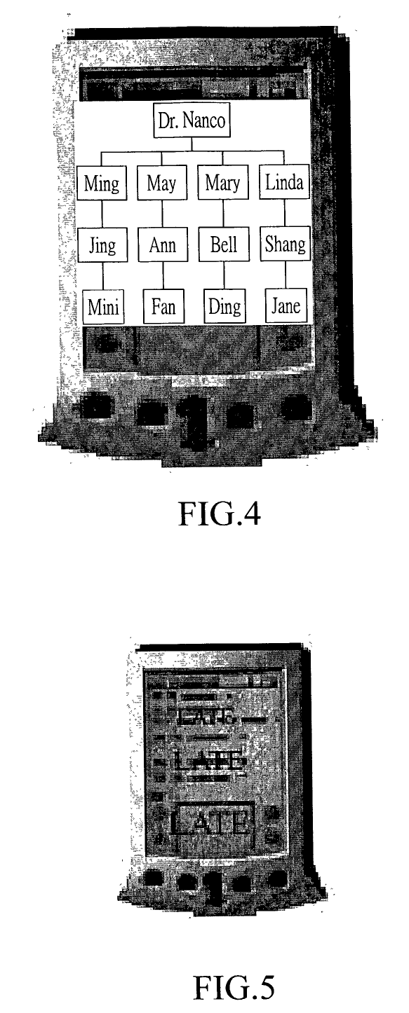

In the aforesaid step of displaying and recording the registration result of learner device, the registration information can be in the format of text, figure or image, and displayed in real time on the instructor device. For a better interaction, a timing process can also be included. The process includes steps of: counting a time period T after a class starts; adding a “LATE” tag to a learner's registration information displayed on the instructor device when the learner logs in after the time period T; and transmitting a “LATE” notice to the late log-in learner's device when the learner logs in after the time period T. The time period T is determined by the instructor for allowing the learner's maximum delay time of attendance in the class. Therefore, when a learner attends the class late after time period T, a “LATE” tag (for example, a different color of display as shown in FIG. 4) will be accompanied with the registration information of the learner for attention of the instructor; and a notice, as shown in FIG. 5, will be provided to the learner for improvement of future attendance. The “LATE” notice can be in a format of text, verbal message or figures, etc.

The communication protocol for the portable data processing/communication devices can be any known methods, such as infrared transmission, Bluetooth, IEEE 802.11a, IEEE 802.11b or HomeRF.

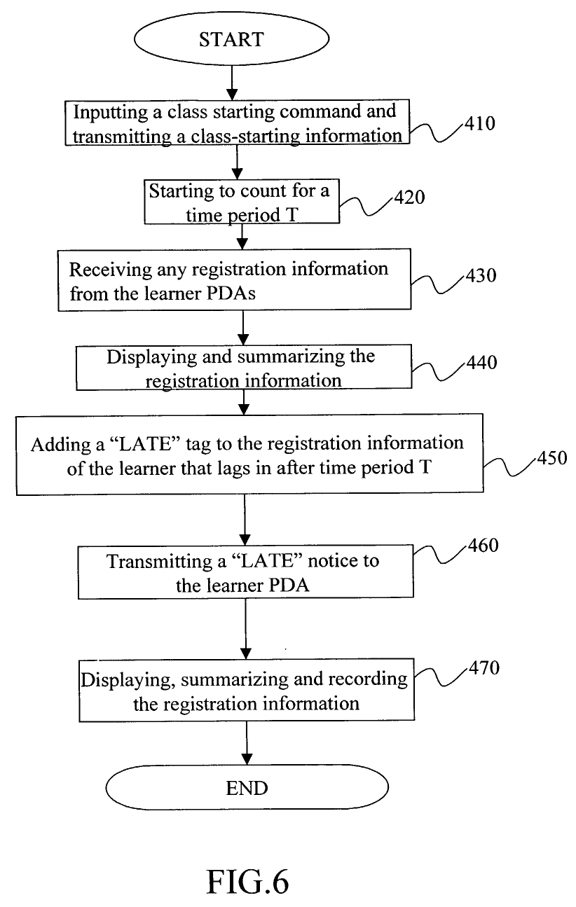

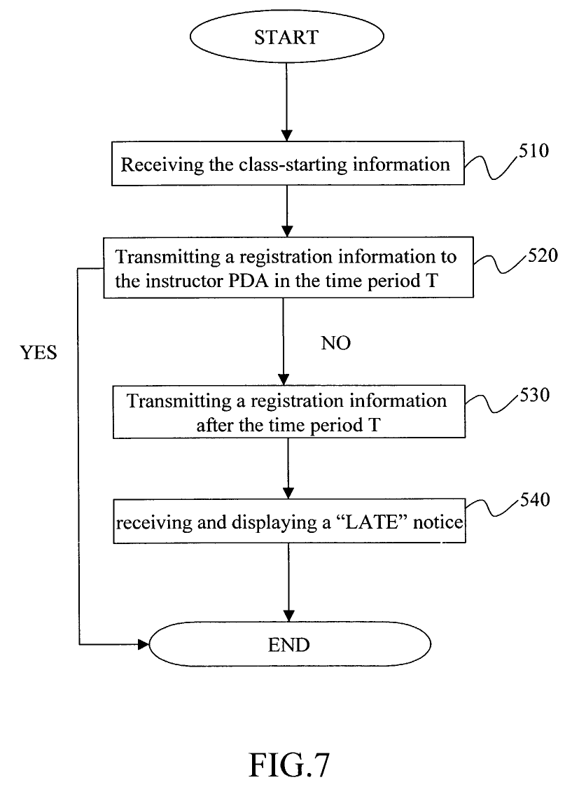

The interactive instructional system of an embodiment of the invention is composed of an instructor PDA and several learner PDAs. The method of logging in the interactive instructional system includes interactions between the instructor PDA and each learner PDA. The flowcharts of the processes in the instructor PDA and the learner PDA are illustrated in FIG. 6 and FIG. 7 respectively.

In FIG. 6, the operational process in the instructor PDA includes the following steps. First, inputting a class-starting command and transmitting a class-starting information with the instructor PDA (step 410) by the instructor (teacher). Meanwhile, starting to count for a time period T (step 420). Then, receiving any registration information from the learner PDAs (step 430). And then, displaying and summarizing the registration information (step 440). After the time period T, adding a “LATE” tag to the registration information of the learner that lags in then (step 450), and transmitting a “LATE” notice to the learner PDA (step 460). Finally, displaying, summarizing and recording the registration information (step 470) for further reference of attendance condition of the learners.

In FIG. 7, the operational process in the learner PDA includes the following steps. First, receiving the class-starting information when joining the local-area network (step 510). Then, transmitting a registration information to the instructor PDA (step 520). The registration information is inputted by the learner though operation of a log-in key. If the registration is sent in the time period T, the log-in is finished. Otherwise, the registration is sent after the time period T (step 530), the learner PDA will receive and display a “LATE” notice (step 540) after the registration.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An interactive instructional system applicable to a wireless local-area network, comprising an instructor portable data communication and processing device and a plurality of learner instructor portable data communication and processing devices;
said instructor portable data communication and processing device comprises an input unit for input of instructional commands and related information; a wireless transceiver for transmitting instructional information to said plurality of learner portable data processing and communication devices, and receiving registration information from said devices; a memory unit for storing said registration information of said learner portable data processing and communication devices; a display unit for displaying said registration information; and a central processing unit connected with said input unit, wireless transceiver, memory unit and display unit for executing registration commands for transmitting information through said wireless transceiver, and transferring information received by said transceiver to said display unit and memory unit;
each of said learner instructor portable data communication and processing devices comprises a wireless transceiver for receiving instructional information from said instructor portable data processing and communication device, and transmitting registration information to said instructor device; an input unit for input of registration information; a display unit for displaying said instructional information; a memory unit for storing said instructional information of said instructor portable data processing and communication device; and a central processing unit connected with said input unit, wireless transceiver, memory unit and display unit for executing said instructional commands and transmitting information through said wireless transceiver, and transferring said information received by said transceiver to said display unit and memory unit.

2. An interactive instructional system according to claim 1, wherein said portable data communication and processing devices are chosen from personal digital assistants, notebook computers and mobile phones.

3. An interactive instructional system according to claim 1, wherein said local-area network uses protocol at least one of infrared transmission, Bluetooth, IEEE 802.11a, IEEE 802.11b and HomeRF.

4. A method for logging in an interactive instructional system based on a wireless local-area network, comprising steps of:
starting a local-area network among learner and instructor portable data processing and communication devices;
inputting a class-starting command for setting said learner and instructor portable data processing and communication devices into a class-staring mode;
transmitting registration information from said learner portable data processing and communication devices to said instructor portable data processing and communication device;
receiving registration information by said instructor portable data processing and communication device;
identifying corresponding positions of said learner portable data processing and communication devices according to said registration information; and
displaying and recording said registration information of learner devices at said instructor device.

5. A method for logging in an interactive instructional system according to claim 4, wherein said portable data communication and processing devices are chosen from personal digital assistants, notebook computers and mobile phones.

6. A method for logging in an interactive instructional system according to claim 4, wherein said local-area network uses protocol at least one of infrared transmission, Bluetooth, IEEE 802.11a, IEEE 802.11b and HomeRF.

7. A method for logging in an interactive instructional system according to claim 4, wherein said step of transmitting registration information from said learner portable data processing and communication devices to said instructor portable data processing and communication device comprises a step of operating a log-in key by said learner at said learner device.

8. A. method for logging in an interactive instructional system according to claim 4, further comprises a step of counting a time period T after inputting said class-starting command.

9. A method for logging in an interactive instructional system according to claim 8, wherein said step of counting a time period T further comprises a step of adding a “LATE” tag to a learner's registration information displayed on said instructor device when said learner logs in after said time period T.

10. A method for logging in an interactive instructional system according to claim 8, wherein said time period T is a predetermined time for allowance of late attendance to said class.

11. A method for logging in an interactive instructional system according to claim 8, wherein said step of counting a time period T further comprises a step of sending a “LATE” notice to said learner device from said instructor device when said learner logs in after said time period T.

12. A method for logging in an interactive instructional system according to claim 11, wherein said “LATE” notice is in a format chosen from text, verbal message and figures.

13. A method for logging in an interactive instructional system based on a wireless local-area network, comprising steps of:
starting a local-area network among learner and instructor personal digital assistants;
inputting a class-starting command for setting said learner and instructor personal digital assistants into a class-staring mode;
transmitting registration information from said learner personal digital assistants to said instructor personal digital assistant;
receiving registration information by said instructor personal digital assistant;
identifying corresponding positions of said learner personal digital assistants according to said registration information; and
displaying and recording said registration information of learner personal digital assistants at said instructor personal digital assistant.

14. A method for logging in an interactive instructional system according to claim 13, wherein said local-area network uses protocol at least one of infrared transmission, Bluetooth, IEEE 802.11a, IEEE 802.11b and HomeRF.

15. A method for logging in an interactive instructional system according to claim 13, wherein said step of transmitting registration information from said learner personal digital assistants to said instructor personal digital assistant comprises a step of operating a log-in key by said learner at said learner personal digital assistant.

16. A method for logging in an interactive instructional system according to claim 13, further comprises a step of counting a time period T after inputting said class-starting command.

17. A method for logging in an interactive instructional system according to claim 16, wherein said step of counting a time period T further comprises a step of adding a “LATE” tag to a learner's registration information displayed on said instructor personal digital assistant when said learner logs in after said time period T.

18. A method for logging in an interactive instructional system according to claim 16, wherein said time period T is a predetermined time for allowance of late attendance to said class.

19. A method for logging in an interactive instructional system according to claim 16, wherein said step of counting a time period T further comprises a step of sending a “LATE” notice to said learner personal digital assistant from said instructor personal digital assistant when said learner logs in after said time period T.

20. A method for logging in an interactive instructional system according to claim 11, wherein said “LATE” notice is in a format chosen from text, verbal message and figures.
